(19) United States
(12) Patent Application Publication
(10) Pub. No.: US 2018/0139979 A1
(43) Pub. Date: May 24, 2018

(54) PORTABLE BREWING CONTAINER

(71) Applicant: Juanita Glynn, East Boston, MA (US)

(72) Inventor: Juanita Glynn, East Boston, MA (US)

(21) Appl. No.: 15/356,692

(22) Filed: Nov. 21, 2016

(51) Int. Cl. A23F 5/26; A47J 31/00; A47J 31/44

(52) U.S. Cl. CPC A23F 5/26; A47J 31/4403; A47J 31/005

(57) ABSTRACT

A combination coffeemaker and travel mug is provided. The portable brewing container is configured to allow users to brew coffee or other beverages while on the go, such as when travelling in an automobile. The present invention may be particularly advantageous for those who frequently travel, such as business travelers, truck drivers, commuters, and the like.

### BACKGROUND OF THE INVENTION

### Field of the Invention

The present invention relates generally to portable brewing containers. More particularly the present invention relates to a portable latte, coffee, and iced coffee maker-mug combination which automatically brews coffee and other brewable beverages.

### Description of Related Art

Coffee and tea are two of the most widely consumed beverages worldwide. Many consumers enjoy multiple cups a day. Currently, the primary ways to obtain such beverages are to make it yourself using an at-home machine which typically is large and rests on a countertop, or to buy it from a shop. Making these beverages requires that the user be at home or at another fixed location. Even if the drink is placed in a “to-go” mug, time and effort must be expended to brew the beverage before leaving. Buying the beverage from a shop also takes time. Between waiting in line, stopping what is being done to go to the shop, and the general disruption, “quick” coffee stops are rarely quick. Also, buying the beverage results in added costs for the user. In today's society, many people are on the go and in a rush, therefore, any time and cost savings are highly desirable.

Therefore, what is needed is a combination brewing system and travel mug that may allow a user to brew a desired beverage in the travel mug itself, and then drink the beverage from the same vessel.

### SUMMARY OF THE INVENTION

The subject matter of this application may involve, in some cases, interrelated products, alternative solutions to a particular problem, and/or a plurality of different uses of a single system or article.

In one aspect, a portable brewing mug system is provided. The brewing mug system has a body which defines an interior chamber and a top opening providing access to the chamber. A tray is removably positioned in the interior chamber adjacent to the top opening. This tray has a filter allowing fluid to flow through and is configured to support and hold a quantity of brewing material such as coffee or tea. A cover is removably attachable to the body to cover the top opening and provide a water-tight seal to the opening when closed. The cover includes a sipping spout to allow drinking of a fluid within the chamber after a brewing process. The cover also may have a display positioned on a top face. The display may be configured to provide display outputs regarding, for example, a status of the brewing operation within the mug, internal temperature, selected brew status, ready status, and the like. The cover may further be configured to include an input source which allows a control input to initiate a brewing cycle within the chamber.

Inside the chamber is a fluid flow region which is positioned and configured to allow fluid flow from within the chamber up to the tray. Fluid flow through the region may be provided in any manner, for example by a pump, among other things. Controlling all of the operation of the brewing mug is a controller, which is configured to receive the input from the input source, initiate a brewing cycle within the chamber, and provide an output to the display.

In another aspect, a method of brewing using a portable brewing mug system is provided. The method may begin with filling, at least partially, an interior chamber of the brewing mug system. The brewing mug system may also have a body which defines an interior chamber and a top opening providing access to the chamber. A tray is removably positioned in the interior chamber adjacent to the top opening. This tray has a filter allowing fluid to flow through and is configured to support and hold a quantity of brewing material such as coffee or tea. A cover is removably attachable to the body to cover the top opening and provide a water-tight seal to the opening when closed. The cover includes a sipping spout to allow drinking of a fluid within the chamber after a brewing process. The cover also may have a display positioned on a top face. The display may be configured to provide display outputs regarding, for example, a status of the brewing operation within the mug, internal temperature, selected brew status, ready status, and the like. The cover may further be configured to include an input source which allows a control input to initiate a brewing cycle within the chamber.

Inside the chamber is a fluid flow region which is positioned and configured to allow fluid flow from within the chamber up to the tray. Fluid flow through the region may be provided in any manner, for example by a pump, among other things.

A quantity of brewing material such as ground coffee or tea leaves may be placed into the tray. The cover may then be closed over the top opening, containing the fluid and brewing material within the brewing mug system. The brewing may begin by activating the brewing system, which may be achieved by actuating the input source. This actuation sends a signal to a controller such as a microprocessor. The microprocessor may then activate the pump or other fluid flow mechanism for a predetermined period of time, so that it passes over the quantity of brewing material at least once and potentially more than once.

### BRIEF DESCRIPTION OF THE DRAWINGS

FIG. 1 provides a perspective view of an embodiment of the present invention.

FIG. 2 provides a side cutaway view of one embodiment of the present invention.

FIG. 3 provides a side cutaway view of another embodiment of the present invention.

FIG. 4 provides a side cutaway view of yet another embodiment of the present invention.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

Generally, the present invention concerns a portable combination brewing device and container. The container is generally formed as a travel mug that may have insulated side walls. A filter tray provides an area in which to place coffee grounds, tea, powdered beverages, and the like. Fluid may pass through this filter tray which brews the beverage. This brewed beverage may then be drank by the user in the same vessel it was brewed in. Optionally, the portable brewing container may include additional features including a battery that provides electronic functionality to the container, a display screen, temperature control settings, hot coffee, latte, and iced coffee options, centrifugal force whipping magnets, a whisking device, heaters, fluid flow channels, separate milk and water reservoirs, and the like.

The portable brewing container may be formed of any materials suitable for containing both hot and cold fluids. Generally, components of the invention may be formed of plastics and/or metals. However, other materials such as glass, wood, composite materials, and the like may be used without straying from the scope of the present invention.

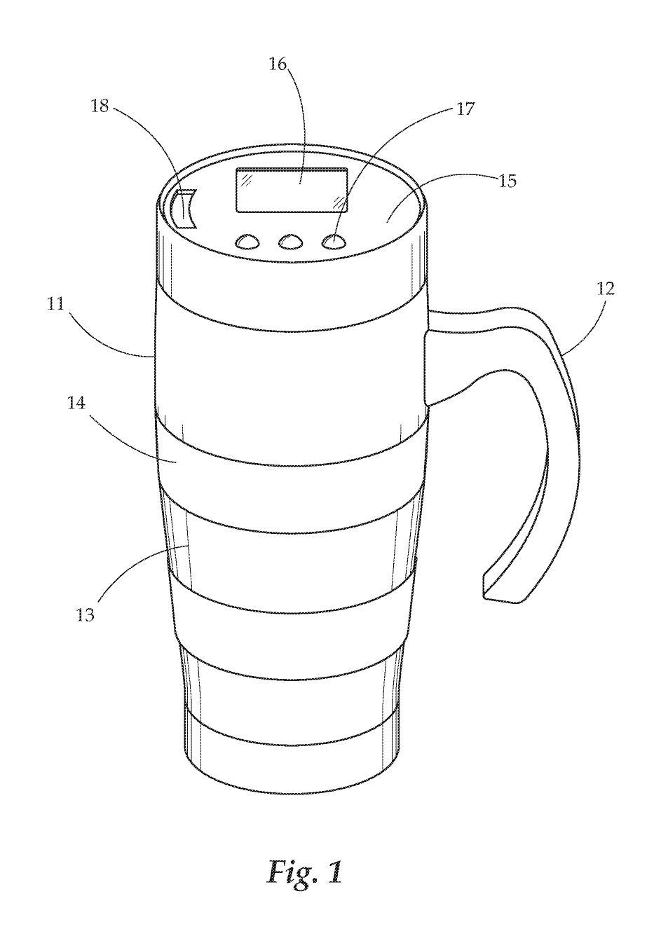

Turning now to FIG. 1, an embodiment of the present invention is provided. The portable brewing container is formed of an insulated body 11 which defines an interior chamber for storage of fluid and the brewing components. A handle 12 is attached to the body. Decorative outer surface features include a mirrored finish 13 and/or frosted finish 14. A top cover 15 seals the top opening of the body to prevent spills and keep the fluid therein insulated. The cover 15 forms a sipping opening 18 which allows a user to during the contents of the container. On the cover 15 is a display screen 16 which may display information regarding the status of the brewing device. For example, the display 16 may show that brewing is ready, brewing is completed, the drink is ready for consumption, error messages, and the like. Three buttons 17 are positioned on the cover 15. These buttons 17 may control and trigger action by the brewing components. In varying embodiments, there may be more or less than three buttons 17. Also, buttons 17 may be replaced with touch sensors and any other input source.

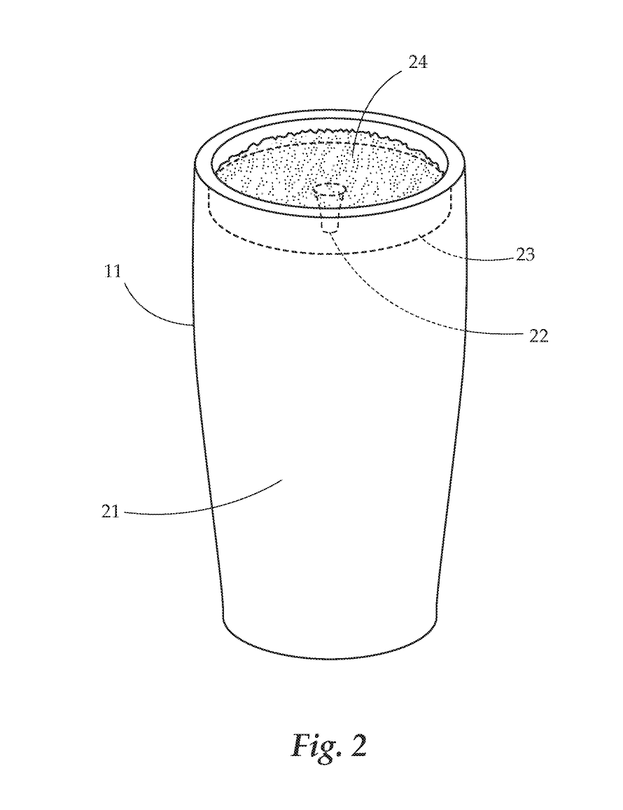

FIG. 2 shows a cutaway view of an embodiment of the present invention. This view shows the body 11 walls and the chamber 21 formed by the body 11. Near a top of the chamber 21 and body 11, adjacent to the body top opening, is the filter tray 23. Filter tray 23 has a filtering area and may operate to contain brewing grounds 24 such as coffee grounds within as water passes through the grounds 24 and filter tray 23 into the chamber. Fluid passing through filter may flow towards spout 22 and into chamber 21. The filter of the tray 23 may be, for example, a fine mesh filter, a paper filter, a fabric filter, and the like.

In a particular embodiment, the tray 23 may form a notch or recess that allows fluid to flow directly through the tray 23. This notch (not shown) may be configured to align with the sipping spout 18 of the cover, so that the beverage once brewed may be directly sipped without interference or interaction with the ground material 24. To ensure alignment of the tray notch with the sipping spout 18, camming protrusions, recesses, or other aligning structure may be formed into the body and the tray to guide the tray into proper rotational alignment. Similarly, cover may be configured to secure at a particular point once in the closed position that aligns with the notch of the tray 23. Alternatively, the ground material 24 and/or tray 23 maybe completely removed before drinking.

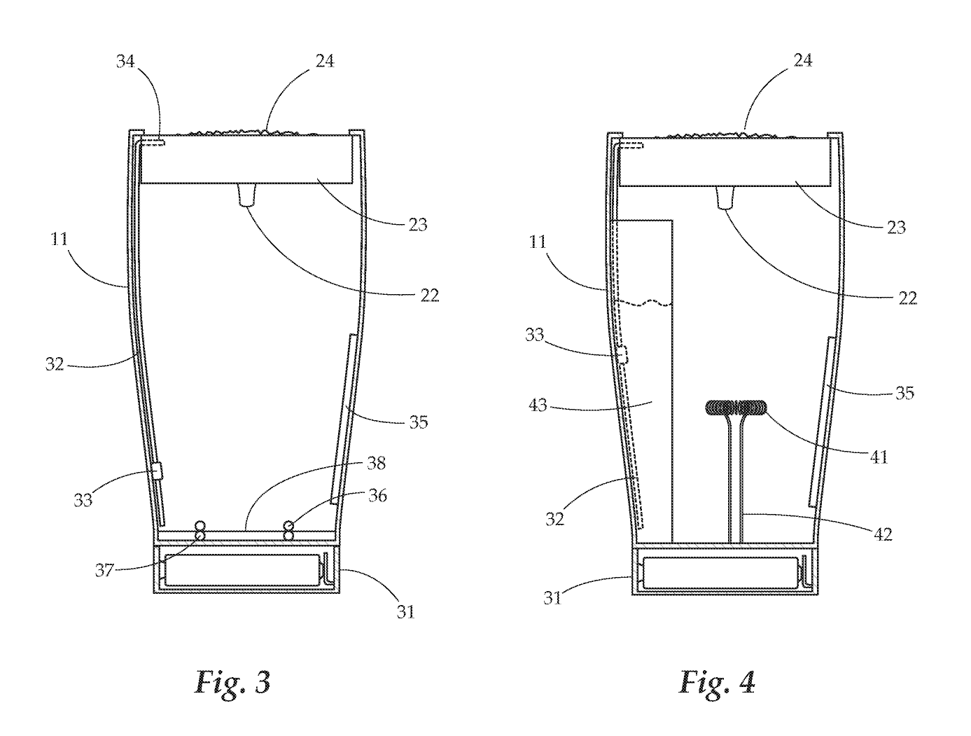

FIG. 3 provides a cutaway view of another embodiment of the present invention. In this view, body 11 forms chamber 21 which contains multiple brewing components. Near a top of the chamber 21 and body 11 adjacent to the top opening is the filter tray 23. Filter tray 23 may operate to contain brewing grounds 24 such as coffee grounds as water passes through the grounds 24 and filter tray 23 into the chamber. Fluid passing through filter may flow towards spout 22 and into chamber 21. A fluid flow region, shown here as tubing 32 runs along a side of the chamber 21 from near a bottom to the top. A pump 33 is positioned in communication with the tubing 32 which provides flow capabilities of fluid in chamber 21 through the tubing 32. An outlet 34 of the tubing 32 empties into, above, or below (such that fluid is urged up through the grounds) the grounds 24 allowing fluid to flow through the grounds 24 and filter tray 23 to brew the beverage. This fluid may be, for example, hot or cold water, sugar water, milk, cream, a mixture of these, and the like. In this embodiment, un-brewed fluid may be placed into the chamber 21, and then the coffee grounds 24 and filter tray 23 may be removably placed into a seat on the body 11 and chamber 21. The pump 33 may then be activated to flow fluid from the chamber 21 into the grounds 24. The outlet 34 may be positioned to guide fluid into the grounds 24 pile. As the fluid passes through the grounds 24, it is brewed and filtered through filter tray 23.

A heating coil 35 or coils may be positioned along the body 11 on the chamber 21 side. The heating coils may heat the fluid either before or after brewing. A battery pack 31 is positioned on a bottom of the body 11. The battery pack 31 provides electronic functionality to the components of the brewing device, including the display screen (not shown), pump 33, heater 35, and the like.

A magnetic centrifugal stirring device 38 is positioned at a bottom of the chamber 21. In one embodiment, this stirring device utilizes a magnet 37 and related electrical components powered by battery 31 to rotate a stirrer 36 within the chamber 21. At operational speeds, magnetic stirring device 38 may dissolve sugar, evenly distribute milk or cream, and at high operational speeds may even froth milk or cream. The advantage to the physical separation between magnet 37 and stirrer 36 is that the operational components are fully separated from the contents in the chamber 21. Similarly, stirrers 36 are formed at least partially of a magnet or magnetic metal that is easily cleaned and not damaged by water, coffee, milk and the like. Magnet 37 may be, for example, an electromagnet that is circular or arranged with multiple components in a ring or other rounded shape. The magnet 37 may then activate in series to drive a magnetic force along the ring shape. An item caught in the field of the magnet 37 may be drawn in motion and may stir contents of the chamber 21. In another embodiment, magnet 37 may be a physically rotating magnet or magnetic metal beneath the chamber wall. Stirrers 36 in communication with the magnet will be drawn in a motion mirroring the magnet's 37 motion because of the magnetic attraction between stirrer 36 and magnet 37. In this embodiment, magnet and magnetic metal components may be reversed without straying from the scope of the present invention.

FIG. 4 provides a cutaway view of another embodiment of the present invention. In this embodiment, the chamber 21 contains a secondary reservoir 43. This embodiment may be useful for latte production among others. The reservoir 43 may be filled with a small amount of water and the filter assembly 22, 23, 24 may be configured to produce a small amount of concentrated beverage, such as an espresso or espresso like coffee. Pump 33 conveys fluid through tube 32 into the grounds 24. In one embodiment, the pump 33 may be a high pressure pump or heating pump that may allow for steam transfer through the grounds 24.

Milk may be positioned in the chamber 21 separated from the water in reservoir 43 used for coffee production. The milk may mix with the concentrated brew to produce a latte or latte-like drink. Heater 35 provides heating or supplemental heating as powered by battery 31. A powered whisk 41 is connected to base 42 and in communication with the battery 31. Whisk 41 may vibrate or rotate rapidly to provide mixing, and at high speeds may froth milk or cream within chamber 21. In other embodiments, a magnetic stirrer 36, 37 may be used as an alternative to or in addition to the whisk 41.

In an embodiment of use, a user may fill the chamber 21 with a fluid such as water for use in brewing the beverage—in this case a coffee beverage. Next, fresh coffee grounds 24 may be placed in the removable filter tray 23. The cover 15 may be sealed onto the top of the body 11, covering the opening to the chamber 21. A button 17 may be actuated to trigger the brewing process. The status of this process may be displayed on the screen 16. Status indicators may indicate the brewing cycle selected (such as latte, hot coffee, iced coffee), status (such as brewing, completed); internal temperature, and the like. Once the brewing cycle is actuated, an electronic controller such as a microchip or computerized controller activates pump 33, which circulates the fluid in the chamber into and through the coffee grounds 24. The microchip may be programmed to activate pump 33 for a predetermined period of time such that the brewing cycle has completed. In some embodiments, brewed beverage may be re-cycled through the grounds multiple times to achieve a desired strength of the brew. This re-cycling and cycling time may be adjustable based on an input from buttons 17 or other input, and the strength of the brew selection may be displayed on the screen 16. For example, a user may select between weak; medium; and strong to adjust a cycle time of the fluid flow through the grounds.

Electric power for pump, display, microchip, and the other electronic components is provided by battery pack 31 and related wiring (not shown). In some embodiments, heater 35 may be activated as controlled by microchip to heat the fluid. Further, magnetic stirring assembly 36, 37, 38 or whisk 41 may be activated by the microchip to stir the brewed or brewing beverage before, during, or after the brewing process completes. In one embodiment, a locking mechanism may prevent removal of the cover 15 and/or opening of the sipping opening 18 during the brewing process. Additives such as milk, cream, sugar, and the like may be added either before or after the brewing process has completed.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

What is claimed is:

1. A portable brewing mug system comprising:
a mug body, the body defining an interior chamber and having a top opening;
a tray removably positioned in the interior chamber adjacent to the top opening, the tray comprising a filter;
a cover removably attached to the body and covering the top opening, the cover providing a water-tight seal to the top opening when in a closed position;
a sipping spout formed in the cover, the sipping spout having a closed mode preventing fluid flow through the cover, and an open mode allowing fluid flow through the cover;
a display screen positioned on the cover, the display being configured to provide a display output regarding a status of a brewing operation within the mug;
a fluid flow region positioned within the interior chamber, the fluid flow region configured to move fluid from within the chamber to the tray;
an input source on the cover, the input source capable of receiving an input to initiate a brewing cycle within the chamber;
a controller, the controller configured to receive the input from the input source, to initiate a brewing cycle which comprises fluid flow through the fluid flow region within the interior chamber, and to provide an output to the display.

2. The portable brewing mug system of claim 1 further comprising a quantity of water within the chamber, and comprising a quantity of ground coffee in the tray.

3. The portable brewing mug system of claim 1 wherein the fluid flow region is a tube extending from adjacent to a bottom of the chamber to a top of the chamber by the tray.

4. The portable brewing mug system of claim 1 wherein the controller is configured to brew one of a hot coffee, iced coffee, and latte based on the input from the input source.

5. The portable brewing mug system of claim 1 further comprising a magnetic stirrer, the magnetic stirrer having a first portion within the chamber, and a second portion outside of the chamber in magnetic communication with the first portion, the magnetic stirrer configured to stir contents within the chamber without a physical connection between the first portion and second portion.

6. The portable brewing mug system of claim 5 wherein the first portion comprises at least one of a magnet and magnetic metal.

7. The portable brewing mug system of claim 6 wherein the second portion is a rotating magnet separated from the chamber by a wall.

8. The portable brewing mug system of claim 1 further comprising a whisk within the chamber, the whisk being powered by a power source and configured to agitate contents within the chamber.

9. The portable brewing mug system of claim 1 further comprising a heater within the chamber.

10. The portable brewing mug system of claim 1 further comprising a power source, the power source being a battery, the power source in communication with the controller and display screen.

11. The portable brewing mug system of claim 3 further comprising a pump in communication with the fluid flow region.

12. The portable brewing mug system of claim 11 wherein the controller is configured to activate the pump for a sufficient time such that the quantity of water is cycled through the quantity of ground coffee at least twice.

13. The portable brewing mug system of claim 1 further comprising a reservoir in the chamber, the reservoir separated apart from the chamber and configured to hold a secondary fluid from a fluid within the chamber, the fluid flow region in communication with the reservoir.

14. The portable brewing mug system of claim 1 wherein the input source comprises three buttons positioned on the cover, each of the three buttons in electronic communication with the controller.

15. The portable brewing mug system of claim 1 wherein the controller is a microprocessor.

16. The portable brewing mug system of claim 1 wherein the body comprises an outer surface of at least one of a mirrored metal and a frosted metal.

17. A method of brewing using a portable brewing mug system comprising the steps of:
filling, at least partially, an interior chamber of the portable brewing mug system with a fluid, the portable brewing mug comprising:
a mug body, the body defining the interior chamber and having a top opening;
a tray removably positioned in the interior chamber adjacent to the top opening, the tray comprising a filter;
a cover removably attached to the body and covering the top opening, the cover providing a water-tight seal to the opening when in a closed position;
a sipping spout formed in the cover, the sipping spout having a closed mode preventing fluid flow through the cover, and an open mode allowing fluid flow through the cover;
a display screen positioned on the cover, the display being configured to provide a display output regarding a status of a brewing operation within the mug;
a fluid flow region formed as tubing positioned within the interior chamber, the fluid flow region configured to move fluid from within the chamber to the tray;
an input source on the cover, the input source capable of receiving an input to initiate a brewing cycle within the chamber;
a controller, the controller configured to receive the input from the input source, to initiate a brewing cycle which comprises fluid flow through the fluid flow region within the interior chamber, and to provide an output to the display;
placing a quantity of ground brewing material in the tray;
moving the cover to the closed position to seal the fluid and ground brewing material within the chamber;
activating the brewing system by actuating the input source, the actuation sending a signal to the microprocessor controller, the activating causing the fluid to be circulated at least once over the quantity of ground brewing material.

18. The method of claim 17 further comprising the step of selecting one of three brewing cycles, the three brewing cycles being a hot coffee brewing cycle; an iced coffee brewing cycle; and a latte brewing cycle; the selecting being performed by an actuation of one of three input sources, each input source being a button.

19. The method of claim 17 wherein the step of activating the brewing system further comprises activating a pump for a time sufficient for a total volume of the fluid in the chamber to be passed through the brewing material at least twice.

20. The method of claim 17 wherein the brewing system further comprises a magnetic stirrer, the magnetic stirrer having a first portion within the chamber, and a second portion outside of the chamber in magnetic communication with the first portion, the magnetic stirrer configured to stir contents within the chamber without a physical connection between the first portion and second portion; and
wherein the step of activating the brewing system comprises the step of causing the second portion to create a moving magnetic field which in turn causes the first portion to move following the moving magnetic field.
